(19) United States
(12) Patent Application Publication
(10) Pub. No.: US 2019/0068805 A1
(43) Pub. Date: Feb. 28, 2019

(54) Image communicating apparatus, control method therefor, and non-transitory computer-readble storage medium storing program

(71) Applicant: CANON KABUSHIKI KAISHA, Tokyo (JP)

(72) Inventor: Yasuaki Kawashima, Kawasaki-shi (JP)

(21) Appl. No.: 15/998,537

(22) Filed: Aug. 16, 2018

(30) Foreign Application Priority Data
Aug. 31, 2017 (JP) 2017-167659

(51) Int. Cl. H04N 1/00; H04N 1/327; H04N 1/32

(52) U.S. Cl. CPC H04N 1/00214; H04N 1/324; H04N 1/32797; H04N 1/32708

(57) ABSTRACT

There is provided an image communicating apparatus according to this invention. The image communicating apparatus determines whether to use a FAX server for FAX sending, adds, if it is determined to use the FAX server for the FAX sending, domain information of the FAX server to a destination of the FAX sending, and sends an image to the destination of the FAX sending, that has been added with the domain information.

### BACKGROUND OF THE INVENTION

### Field of the Invention

The present invention relates to an image communicating apparatus, a control method therefor, and a non-transitory computer-readable storage medium storing a program.

### Description of the Related Art

There is provided a technique in which a plurality of IP FAX terminals connected to an IP network send/receive FAX images via a mail server connected to the IP network (see Japanese Patent Laid-Open No. 2007-306297). In this technique, the mail server stores the FAX number of a sending destination and an IP address in linkage with each other, and conversion between the FAX number and the IP address is possible. Therefore, even if the IP FAX terminal as a sending source does not store the IP address of a sending destination, it can send data. However, a problem arises in which no data can be sent unless the mail server stores the IP address and FAX number of a sending destination in linkage with each other.

On the other hand, in recent years, an Internet FAX service is becoming widespread. In this service, the user designates a destination formed by a FAX number and the domain name of an Internet FAX server, and sends data to the Internet FAX server by email or Internet FAX. This causes the Internet FAX server to convert, into G3 FAX data, data sent by email or Internet FAX, and send it to the destination of the FAX number. This service charges no telephone line connection fee, and data can be sent even if the mail server does not store the IP address and FAX number of the sending destination in linkage with each other, unlike the related art.

When performing FAX sending from a multi-function peripheral (MFP) using an Internet FAX server, the MFP actually sends data to the Internet FAX server by email or Internet FAX. Therefore, if the MFP sends data by Internet FAX, it is necessary to input a destination in an email address format using the FAX number and domain information of a sending destination. However, the user of the MFP still performs FAX sending using the MFP. Thus, an operation of inputting the above-described destination is unnatural for the user who has conventionally used the FAX function of the MFP, posing a problem that the convenience degrades.

### SUMMARY OF THE INVENTION

An aspect of the present invention is to eliminate the above-mentioned problems with the conventional technology.

The present invention provides a technique in which even when Internet FAX sending is to be performed, it is possible to perform FAX sending by designating an Internet FAX destination, similarly to sending destination designation processing by the conventional FAX function.

The present invention in one aspect provides an image communicating apparatus comprising: a determination unit configured to determine whether to use a FAX server for FAX sending; an addition unit configured to add, if the determination unit determines to use the FAX server for the FAX sending, domain information of the FAX server to a destination of the FAX sending; and a sending unit configured to send an image to the destination of the FAX sending, that has been added with the domain information by the addition unit.

According to the present invention, even when Internet FAX sending is to be performed, it is possible to perform FAX sending by designating an Internet FAX destination, similarly to sending destination designation processing by the conventional FAX function.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the hardware arrangement of an image communicating apparatus;

FIG. 2 is a view showing an example of the configuration of a communicating system including the image communicating apparatus;

FIG. 3 is a flowchart illustrating main processing by the image communicating apparatus;

FIGS. 4A and 4B are views each showing a screen displayed on a display unit of an operation unit of the image communicating apparatus;

FIG. 5 is a flowchart illustrating setting/registration processing in step S303 of FIG. 3;

FIG. 6 is a flowchart illustrating FAX server setting processing in step S503 of FIG. 5;

FIG. 7 is a view showing a FAX server setting screen displayed on the display unit of the operation unit of the image communicating apparatus;

FIG. 8 is a flowchart illustrating FAX server use setting processing in step S505 of FIG. 5;

FIG. 9 is a view showing a FAX server use setting screen displayed on the display unit of the operation unit of the image communicating apparatus;

FIG. 10 is a flowchart illustrating I-FAX domain setting processing in step S507 of FIG. 5;

FIG. 11 is a view showing an I-FAX domain setting processing screen displayed on the display unit of the operation unit of the image communicating apparatus;

FIG. 12 is a flowchart illustrating FAX processing in step S305 of FIG. 3;

FIGS. 13A and 13B are views respectively showing a FAX screen displayed on the display unit of the operation unit of the image communicating apparatus and a job status guide screen;

FIG. 14 is a flowchart illustrating scan and sending processing in step S307 of FIG. 3;

FIGS. 15A and 15B are views respectively showing a scan screen displayed on the operation unit of the image communicating apparatus and an example of a job status guide screen;

FIG. 16 is a flowchart illustrating destination selection processing in step S1303 of FIG. 12 or step S1603 of FIG. 14;

FIGS. 17A and 17B are views respectively showing an address book screen displayed on the display unit of the operation unit in step S1905 and an address book registration screen on which a FAX destination can also be registered;

FIG. 18 is a view showing an address book registration screen which is displayed on the display unit of the operation unit in step S1916 and on which no FAX destination can be registered;

FIG. 19 is a flowchart illustrating application mode processing in step S1305 of FIG. 12 or step S1605 of FIG. 14;

FIG. 20 is a view showing an application mode screen displayed on the display unit of the operation unit in step S2301;

FIGS. 21A and 21B are flowcharts illustrating sending processing in step S1307 of FIG. 12 or step S1607 of FIG. 14;

FIG. 22 is a flowchart illustrating original scan and sending processing in step S2501 of FIG. 21A;

FIGS. 23A, 23B, and 23C are views each showing a confirmation screen displayed on the display unit of the operation unit;

FIG. 24 is a flowchart illustrating job status processing in step S1310 of FIG. 12 or step S1610 of FIG. 14; and

FIG. 25 is a flowchart illustrating post-processing in step S1311 of FIG. 12 or step S1611 of FIG. 14.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

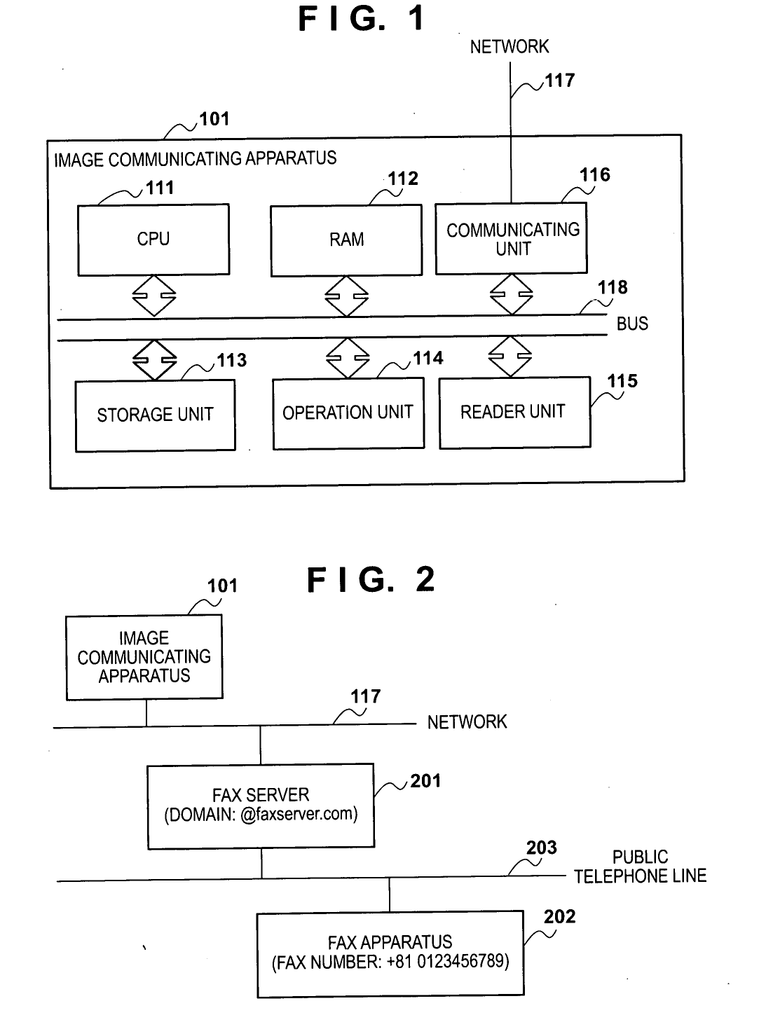

FIG. 1 is a block diagram for explaining the hardware arrangement of an image communicating apparatus 101 according to an embodiment of the present invention.

A CPU 111 controls each unit connected to a bus 118 by loading a program stored in a storage unit 113 into a RAM 112, and executing the loaded program, thereby controlling the operation of the overall image communicating apparatus 101. The RAM 112 provides a work area for the CPU 111. The storage unit 113 is, for example, a hard disk or an SDRAM that stores programs, various settings, files, and the like. The storage unit 113 also stores an address book that stores a sending destination at the time of sending a document by a communicating unit 116, settings of a FAX server, a setting indicating whether to use the FAX server, and the like. An operation unit 114 includes hardware keys and a display unit having a touch panel function, and is used by a user to input various settings and commands via a GUI (Graphic User Interface). A reader unit 115 reads an original to acquire image data of the original. The reader unit 115 includes an automatic original reading device (to be referred to as a document feeder hereinafter) and an original table reading device (to be referred to as a flatbed hereinafter). The communicating unit 116 communicates, via a network 117, with another apparatus connected to the network 117.

FIG. 2 is a view showing an example of the configuration of a communicating system including the image communicating apparatus 101 according to the embodiment.

A FAX server 201 is connected to the image communicating apparatus 101 via the network 117. The FAX server 201 is configured to receive an Internet FAX (to be referred to as an I-FAX hereinafter) of a domain “faxserver.com”. If a portion before the domain name of the sending destination of the received I-FAX indicates a FAX number, a document attached to the I-FAX is sent to the FAX number by FAX. The FAX server 201 is connected to the image communicating apparatus 101 via the network 117, and connected to a FAX apparatus 202 via a public telephone line 203. The FAX apparatus 202 is assigned with “+810123456789” as a FAX number.

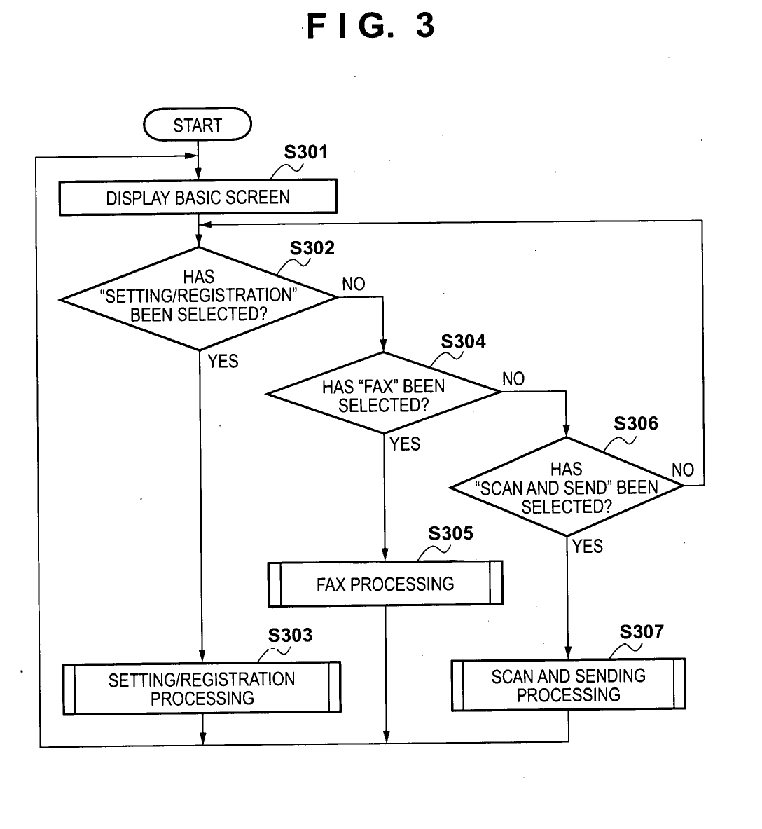

FIG. 3 is a flowchart for explaining main processing by the image communicating apparatus 101 according to the embodiment. The processing of this flowchart is implemented when the CPU 111 loads the program stored in the storage unit 113 into the RAM 112 and executes the loaded program. Note that this processing starts when the image communicating apparatus 101 is powered on.

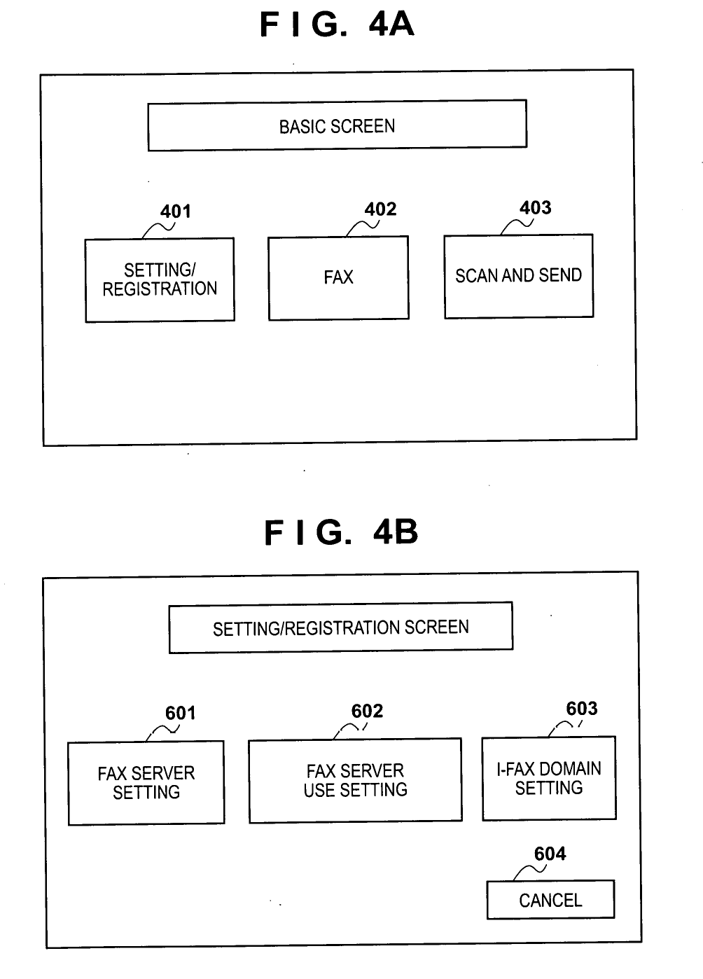

In step S301, the CPU 111 displays a basic screen shown in, for example, FIG. 4 on the display unit of the operation unit 114.

FIG. 4A is a view showing an example of the basic screen (menu screen) displayed on the display unit of the operation unit 114 of the image communicating apparatus 101 according to the embodiment.

On this basic screen, a “setting/registration” button 401, a “FAX” button 402, and a “scan and send” button 403 are displayed.

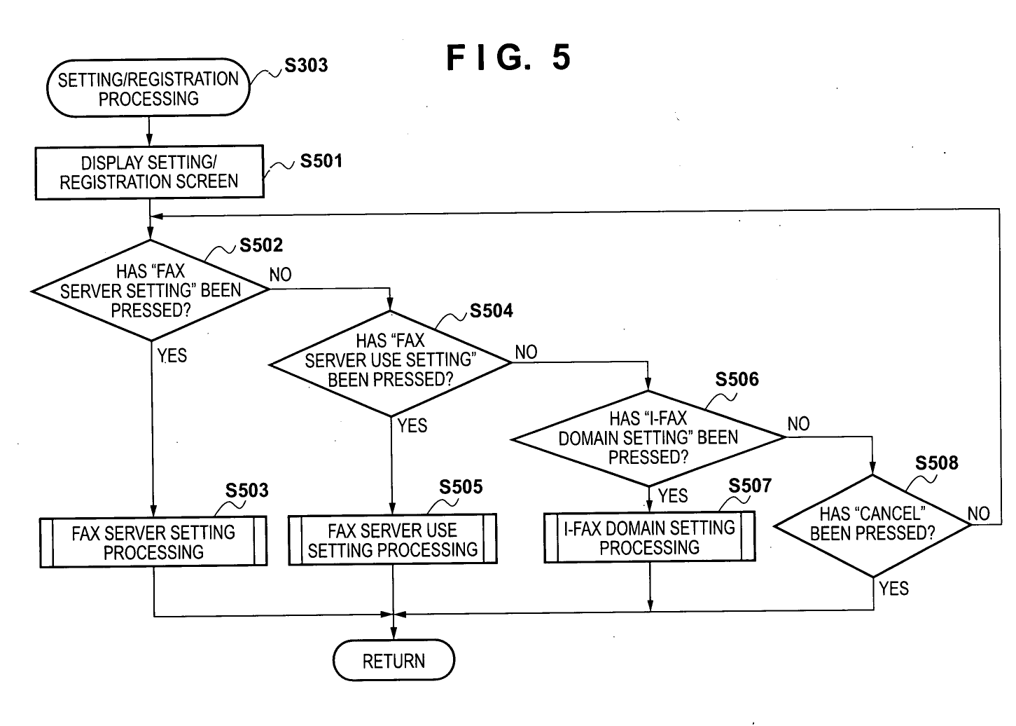

The process advances to step S302, and the CPU 111 determines whether the “setting/registration” button 401 for selecting a setting/registration function has been pressed. If it is determined that the “setting/registration” button 401 has been pressed, the process advances to step S303; otherwise, the process advances to step S304. In step S303, the CPU 111 executes setting/registration processing (to be described later with reference to FIG. 5), and returns to step S301.

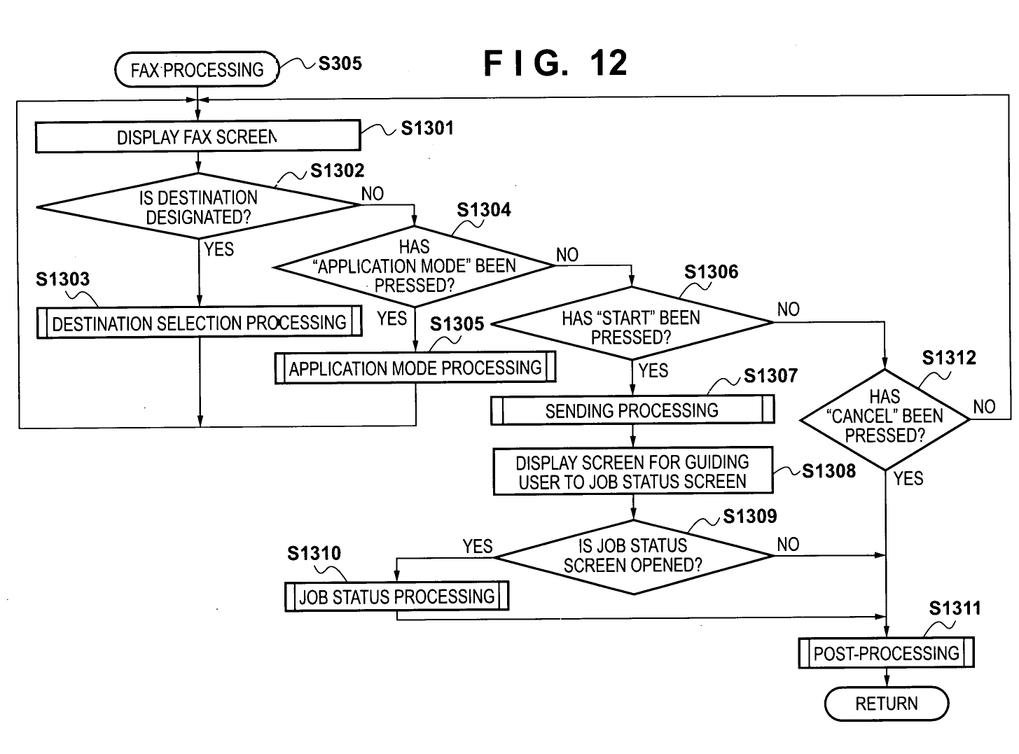

In step S304, the CPU 111 determines whether the “FAX” button 402 for selecting a FAX function has been pressed. If it is determined that the “FAX” button 402 has been pressed, the process advances to step S305; otherwise, the process advances to step S306. In step S305, the CPU 111 executes FAX processing (to be described later with reference to FIG. 12), and returns to step S301.

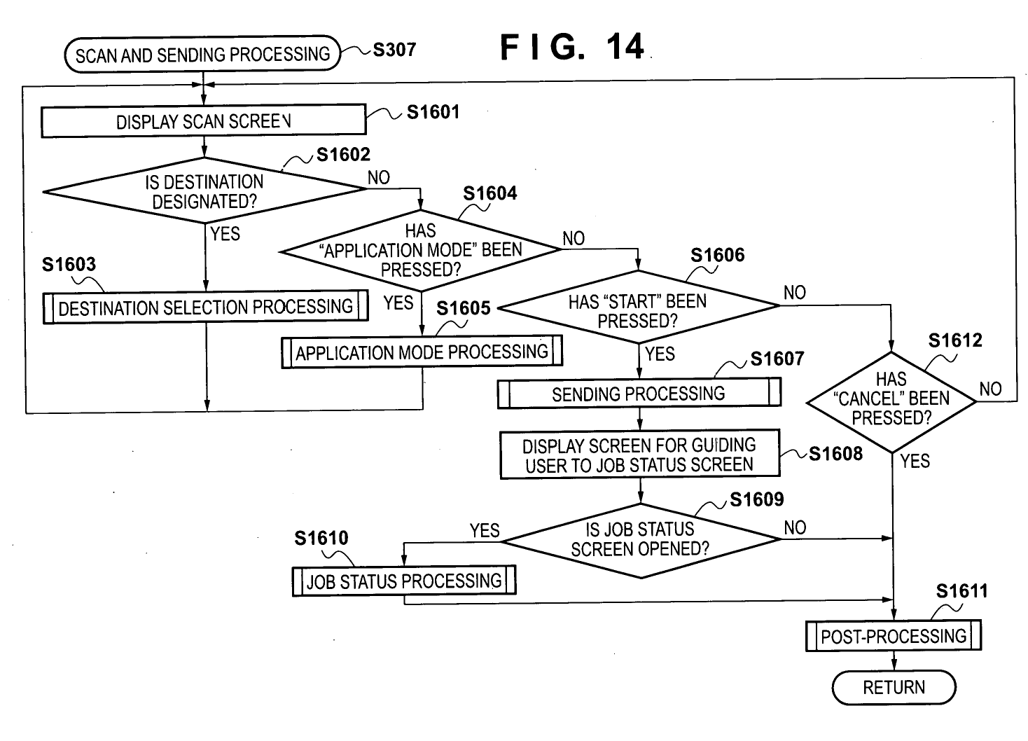

In step S306, the CPU 111 determines whether the “scan and send” button 403 has been pressed. If it is determined that the “scan and send” button 403 has been pressed, the process advances to step S307; otherwise, the process returns to step S301. In step S307, the CPU 111 executes scan and sending processing (to be described later with reference to FIG. 14), and returns to step S301.

FIG. 5 is a flowchart for explaining the setting/registration processing in step S303 of FIG. 3.

Upon start of the setting/registration processing, the CPU 111 displays, in step S501, a setting/registration screen shown in, for example, FIG. 4B on the display unit of the operation unit 114.

FIG. 4B is a view showing an example of the setting/registration screen (setting/registration menu screen) displayed on the display unit of the operation unit 114 of the image communicating apparatus 101 according to the embodiment.

This setting/registration screen includes a “FAX server setting” button 601, a “FAX server use setting” button 602, and an “I-FAX domain setting” button 603.

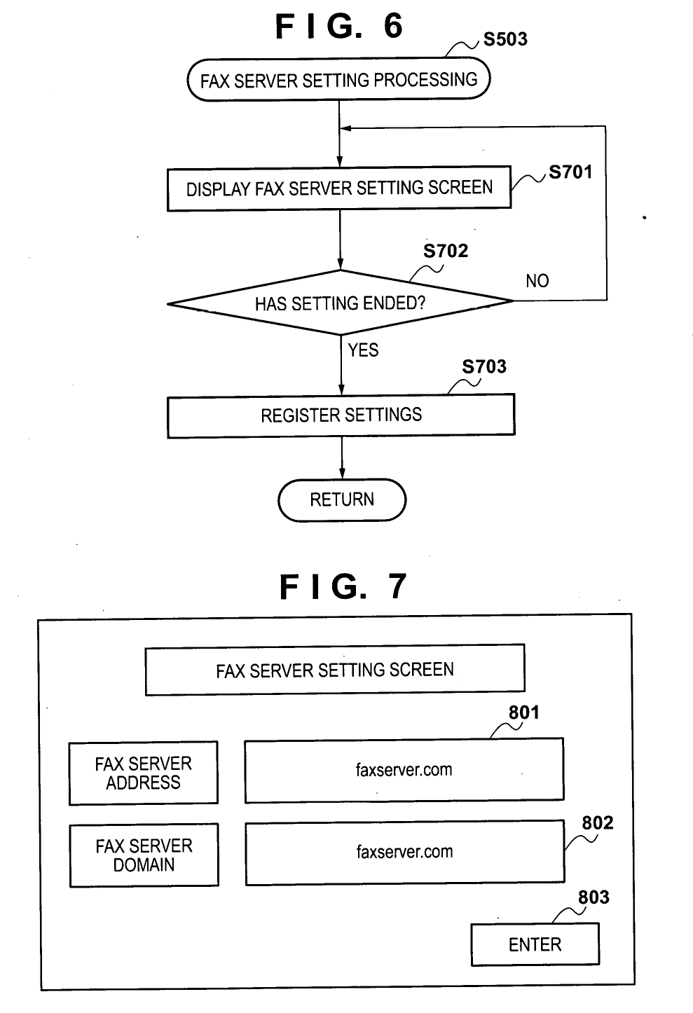

The process advances to step S502, and the CPU 111 determines whether the “FAX server setting” button 601 for making settings of a FAX server has been pressed. If it is determined that the “FAX server setting” button 601 has been pressed, the process advances to step S503; otherwise, the process advances to step S504. In step S503, the CPU 111 executes FAX server setting processing (to be described later with reference to FIG. 6), and ends this processing.

In step S504, the CPU 111 determines whether the “FAX server use setting” button 602 for selecting a FAX server use setting has been pressed. If it is determined that the “FAX server use setting” button 602 has been pressed, the process advances to step S505; otherwise, the process advances to step S506. In step S505, the CPU 111 executes FAX server use setting processing (to be described later with reference to FIG. 8), and ends this processing.

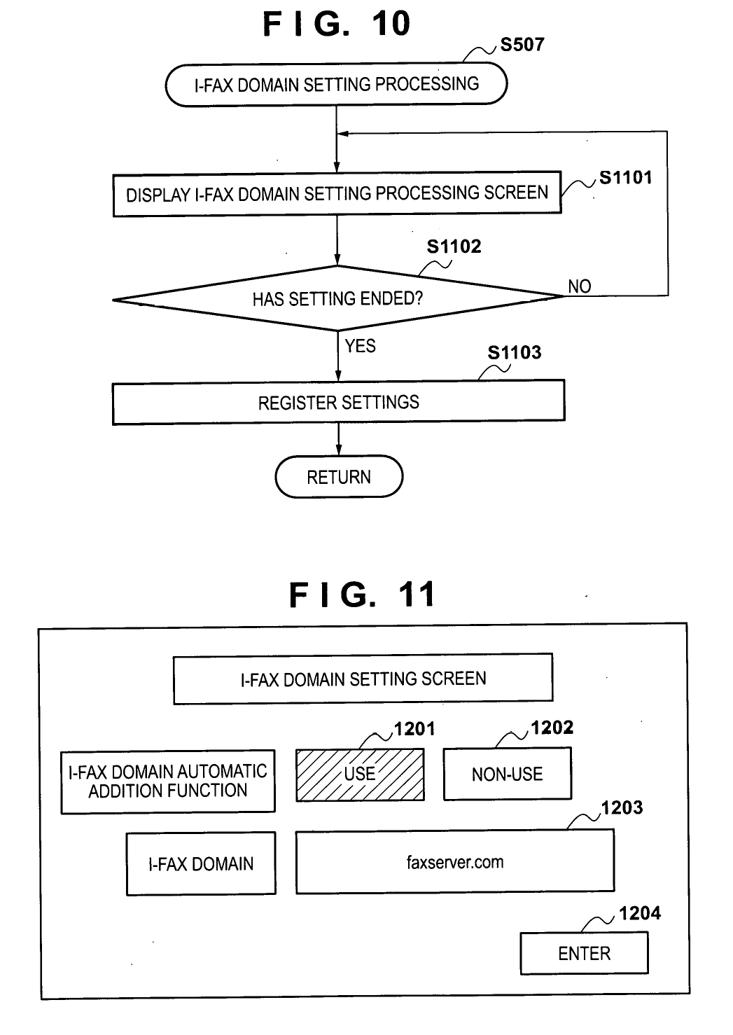

In step S506, the CPU 111 determines whether the “I-FAX domain setting” button 603 has been pressed. If it is determined that the “I-FAX domain setting” button 603 has been pressed, the process advances to step S507; otherwise, the process advances to step S508. In step S507, the CPU 111 executes I-FAX domain setting processing (to be described later with reference to FIG. 10), and ends this processing. In step S508, the CPU 111 determines whether a cancel button 604 has been pressed. If it is determined that the cancel button 604 has been pressed, the CPU 111 ends this processing; otherwise, the CPU 111 returns to step S502.

FIG. 6 is a flowchart for explaining the FAX server setting processing in step S503 of FIG. 5.

Upon start of the FAX server setting processing, the CPU 111 displays, in step S701, a FAX server setting screen shown in, for example, FIG. 7 on the display unit of the operation unit 114.

FIG. 7 is a view showing an example of the FAX server setting screen displayed on the display unit of the operation unit 114 of the image communicating apparatus 101 according to the embodiment.

The user can register, via the FAX server setting screen, FAX server address information 801 and FAX server domain information 802. Then, the user can confirm this registration by pressing an enter button 803.

In step S702, the CPU 111 determines whether the enter button 803 has been pressed to complete the input of the FAX server address information 801 and the FAX server domain information 802. It is determined that the input is complete, the process advances to step S703, and the CPU 111 registers, in the storage unit 113, contents input to the FAX server setting screen, thereby ending this processing. On the other hand, if it is determined in step S702 that no enter button 803 has been pressed, the process returns to step S701.

With this processing, when using a FAX server, it is possible to set the address and domain of the FAX server via the FAX server setting screen.

FIG. 8 is a flowchart for explaining the FAX server use setting processing in step S505 of FIG. 5.

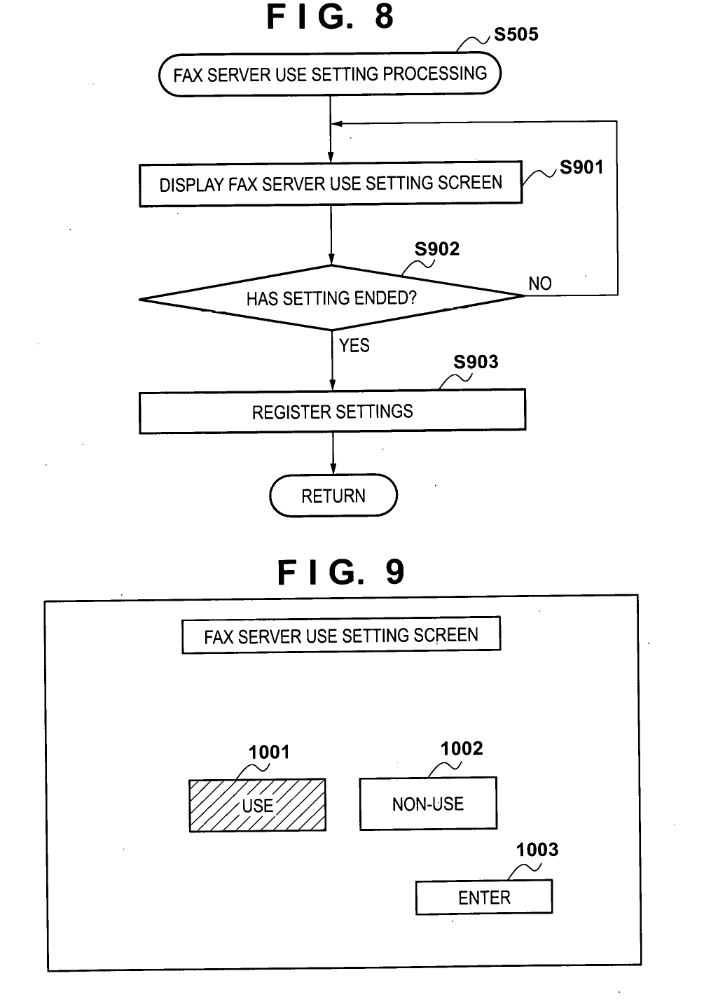

Upon start of the FAX server use setting processing, the CPU 111 displays, in step S901, a FAX server use setting screen shown in, for example, FIG. 9 on the display unit of the operation unit 114.

FIG. 9 is a view showing an example of the FAX server use setting screen displayed on the display unit of the operation unit 114 of the image communicating apparatus 101 according to the embodiment.

The user can select, via the FAX server use setting screen, whether to use the FAX server, by pressing a “use” button 1001 or a “non-use” button 1002. An enter button 1003 is a button for confirming the setting on this screen. In FIG. 9, the “use” button 1001 is selected.

The process advances to step S902, and the CPU 111 determines whether the enter button 1003 has been pressed to complete the setting via this screen. If it is determined that the enter button 1003 has been pressed, the process advances to step S903; otherwise, the process returns to step S901. In step S903, the CPU 111 registers, in the storage unit 113, contents input via the FAX server use setting screen, and ends this processing.

With this processing, it is possible to set, via the FAX server use setting screen, whether to use the FAX server.

FIG. 10 is a flowchart for explaining the I-FAX domain setting processing in step S507 of FIG. 5.

Upon start of the I-FAX domain setting processing, the CPU 111 displays, in step S1101, an I-FAX domain setting processing screen shown in, for example, FIG. 11 on the display unit of the operation unit 114.

FIG. 11 is a view showing an example of the I-FAX domain setting processing screen displayed on the display unit of the operation unit 114 of the image communicating apparatus 101 according to the embodiment.

On this I-FAX domain setting screen, it is possible to designate whether to use an I-FAX domain automatic addition function, by selecting a “use” button 1201 or a “non-use” button 1202. An I-FAX domain to be added can be input to an input field 1203, and registered. The user can set contents input via this screen by pressing an enter button 1204. Referring to FIG. 11, selection is made to use the I-FAX domain automatic addition function.

In step S1102, the CPU 111 determines whether the enter button 1204 has been pressed. If it is determined that the enter button 1204 has been pressed, the process advances to step S1103; otherwise, the process returns to step S1101. In step S1103, the CPU 111 registers, in the storage unit 113, the contents input via the I-FAX domain setting screen, thereby ending this processing.

With this processing, it is possible to set, via the I-FAX domain setting screen, whether to automatically add an I-FAX domain and that I-FAX domain.

FIG. 12 is a flowchart for explaining the FAX processing in step S305 of FIG. 3.

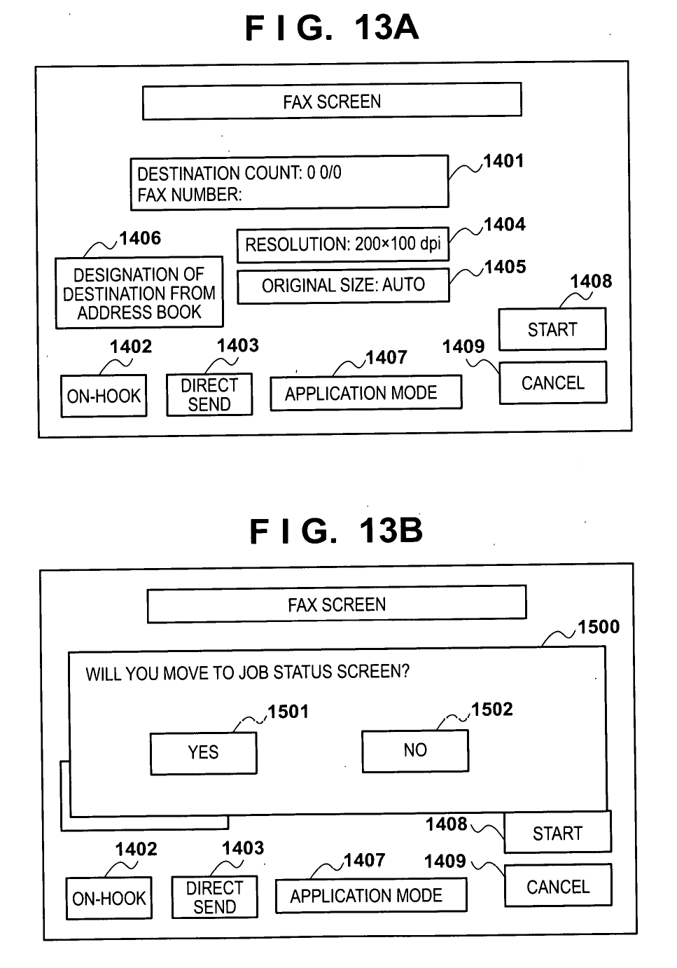

Upon start of this processing, the CPU 111 displays, in step S1301, a FAX screen shown in, for example, FIG. 13A.

FIG. 13A is a view showing an example of the FAX screen displayed on the display unit of the operation unit 114 of the image communicating apparatus 101 according to the embodiment.

On this FAX screen, a destination designated as a sending destination is displayed in a destination display region 1401. In addition, “on-hook” 1402, “direct send” 1403, “reading resolution” 1404, and “original size” 1405 can be set. In the embodiment, on this FAX screen, the above-described items can be set but may not be settable depending on the specifications of the FAX server. The corresponding item may be grayed out to be unselectable, or set in a non-display state. An address book icon 1406 is pressed when designating a destination with reference to an address book.

The process advances to step S1302, and the CPU 111 determines whether the address book icon 1406 has been pressed to select destination selection processing. If it is determined that the destination selection processing has been selected, the process advances to step S1303, and the CPU 111 executes the destination selection processing (to be described later), thereby returning to step S1301. If it is determined in step S1302 that no destination selection processing has been selected, the process advances to step S1304, and the CPU 111 determines whether an application mode button 1407 has been pressed. If it is determined that the application mode button 1407 has been pressed, the process advances to step S1305 to execute application mode processing (to be described later), and then returns to step S1301.

If it is determined in step S1304 that no application mode button 1407 has been pressed, the process advances to step S1306, and the CPU 111 determines whether a start button 1408 has been pressed to issue a sending start instruction. If it is determined in step S1306 that the start button 1408 has been pressed, the process advances to step S1307, and the CPU 111 executes sending processing (to be described later). If it is determined in step S1306 that no start button 1408 has been pressed, the process advances to step S1312, and the CPU 111 determines whether a cancel button 1409 has been pressed. If it is determined that the cancel button 1409 has been pressed, the process advances to step S1311 to execute post-processing and then ends; otherwise, the process returns to step S1301.

After executing the sending processing in step S1307, the process advances to step S1308, and the CPU 111 displays a job status guide screen, shown in FIG. 13B, for prompting the user to select whether to open a job status screen.

FIG. 13B is a view showing an example of a job status guide screen 1500 displayed on the display unit of the operation unit 114 of the image communicating apparatus 101 according to the embodiment. The job status guide screen 1500 pops up on the FAX screen shown in FIG. 13A.

A YES button 1501 is a button for instructing to transit (move) to the job status screen. A NO button 1502 is a button for not instructing to transit to the job status screen.

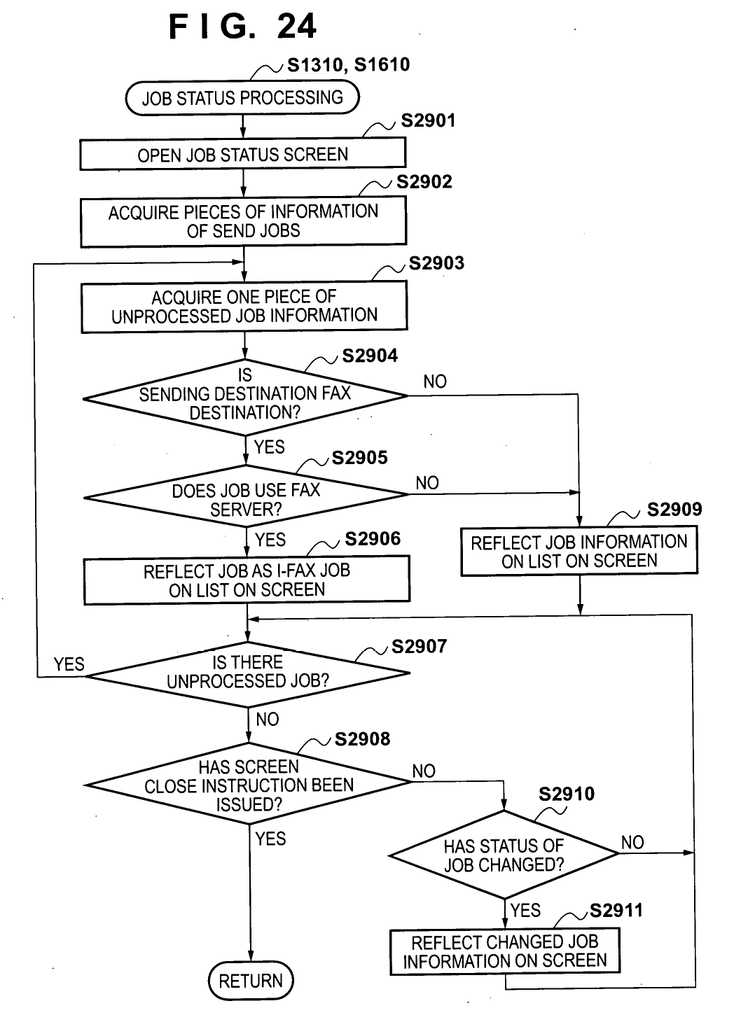

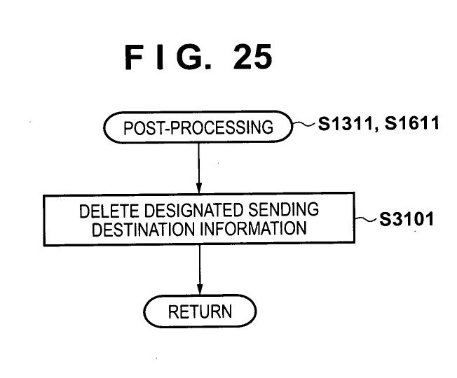

The process advances to step S1309, and the CPU 111 determines whether the YES button 1501 has been pressed. If it is determined that the YES button 1501 has been pressed, the process advances to step S1310, and the CPU 111 executes job status processing (to be described later with reference to FIG. 24). Then, the CPU 111 performs the post-processing in step S1311 (to be described later with reference to FIG. 25), and ends this processing. On the other hand, if it is determined in step S1309 that the NO button 1502 has been pressed, the process advances to step S1311, and the CPU 111 executes the post-processing, and ends this processing.

With this processing, it is possible to start FAX sending by designating a destination, a resolution, an original size, and the like from the FAX screen, and confirm the status of the FAX sending in progress by displaying the job status screen.

The scan and sending processing in step S307 of FIG. 3 will be described next with reference to the flowchart of FIG. 14.

FIG. 14 is the flowchart for explaining the scan and sending processing in step S307 of FIG. 3. This scan and sending processing is basically the same as the FAX processing shown in FIG. 12.

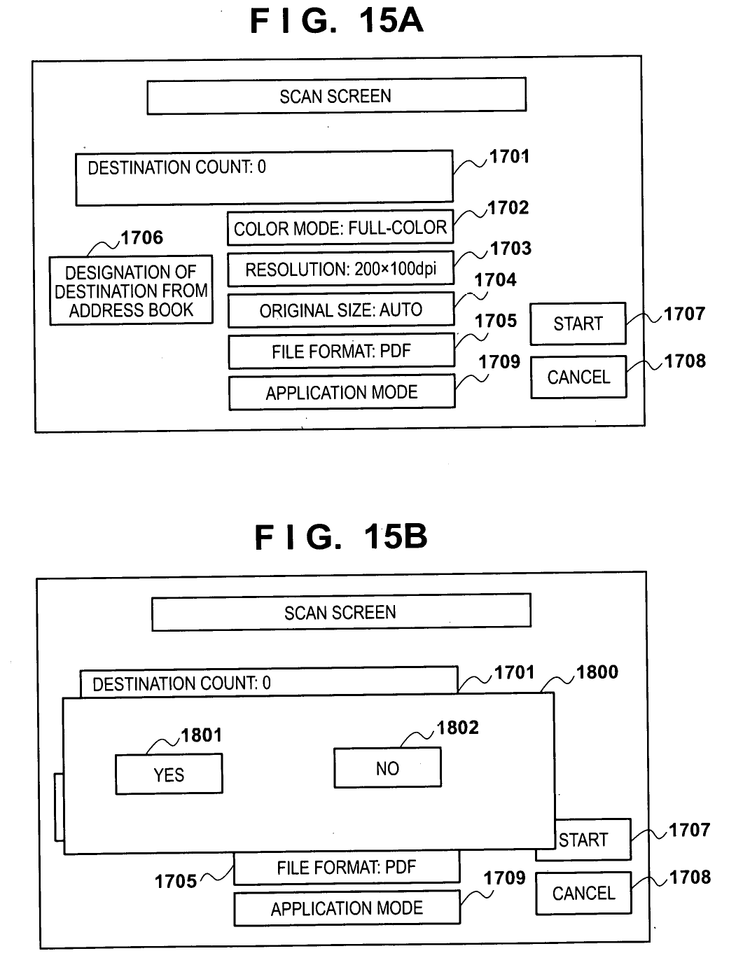

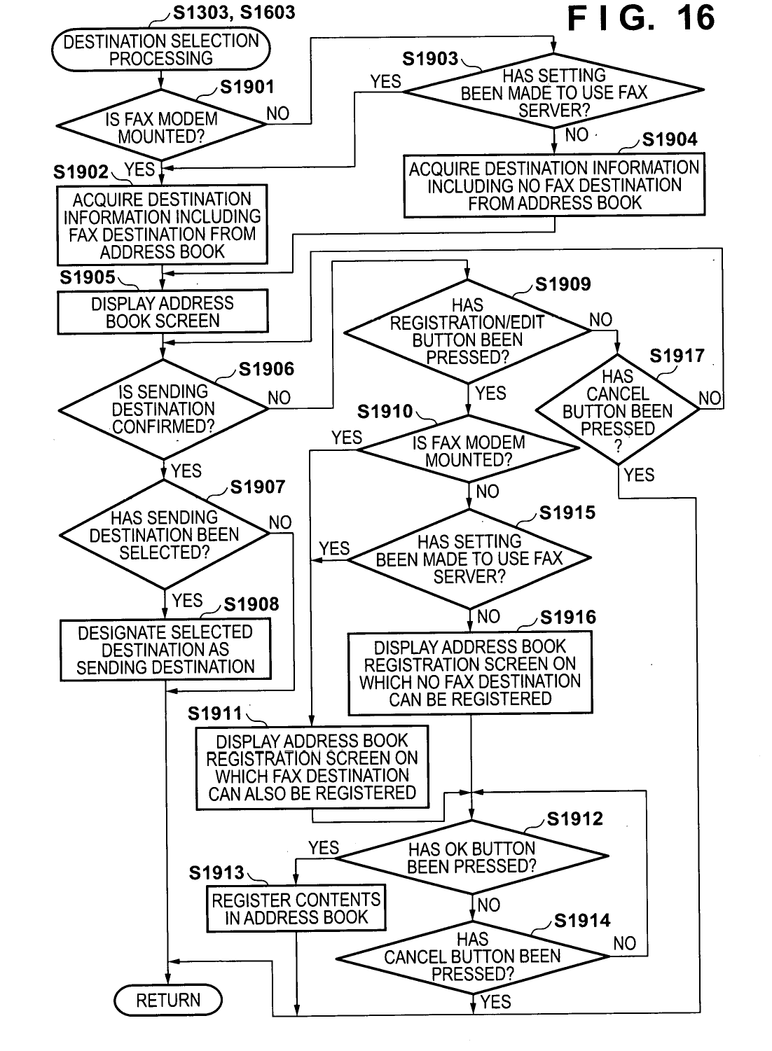

In step S1601, the CPU 111 displays a scan screen shown in, for example, FIG. 15A on the display unit of the operation unit 114.

FIG. 15A is a view showing an example of the scan screen displayed on the operation unit 114 of the image communicating apparatus 101 according to the embodiment.

A destination display region 1701 displays a designated destination. A color mode 1702 indicates a color mode at the time of reading an original, and a full-color mode is designated. A resolution 1703 indicates a resolution at the time of reading the original, and a resolution of 200×100 dpi is set. An original size 1704 indicates the size of the original to be read, and “auto” is set to set a detected original size. A file format 1705 indicates a file format at the time of sending image data of the read original, and a PDF format is set. An address book icon 1706 is pressed when designating a destination with reference to the address book. A start button 1707 is a button for instructing to start reading the original. A cancel button 1708 is a button for canceling the settings via this screen.

Referring back to FIG. 14, in step S1602, the CPU 111 determines whether the address book icon 1706 has been pressed. If it is determined that the address book icon 1706 has been pressed, the process advances to step S1603, and the CPU 111 performs destination selection processing (to be described later). Then, the process returns to step S1601.

If the CPU 111 determines in step S1602 that no address book icon 1706 has been pressed, the process advances to step S1604, and the CPU 111 determines whether an application mode icon 1709 has been pressed to select an application mode. If it is determined that the application mode has been selected, the process advances to step S1605, and the CPU 111 performs application mode processing (to be described later). Then, the process advances to step S1601.

If it is determined in step S1604 that no application mode has been selected, the process advances to step S1606, and the CPU 111 determines whether the start button 1707 has been pressed to issue a sending start instruction. If it is determined that the start button 1707 has been pressed, the process advances to step S1607 to execute sending processing (to be described later), and then advances to step S1608; otherwise, the process advances to step S1612. In step S1612, the CPU 111 determines whether the cancel button 1708 has been pressed to issue a cancel instruction. If it is determined that the cancel instruction has been issued, the process advances to step S1611 to execute post-processing, thereby ending this processing. On the other hand, if it is determined in step S1612 that no cancel instruction has been issued, the process returns to step S1601.

With this processing, it is possible to start the scan and sending processing by designating a destination, a color mode, a resolution, an original size, a file format, and the like from the scan screen, and confirm the status of the scan and sending processing in progress by displaying the job status screen.

FIG. 15B is a view showing an example of a job status guide screen 1800 displayed in step S1608 of FIG. 14.

The job status guide screen 1800 is a screen for prompting the user to select whether to open the job status screen that pops up on the screen shown in FIG. 15A. If a YES button 1801 is pressed to select to open the job status screen, the process advances from step S1609 to step S1610 to execute job status processing (to be described later), and then advances to step S1611 to execute the post-processing (to be described later), thereby ending this processing. On the other hand, if it is determined in step S1609 that a NO button 1802 has been pressed, the user has not selected to open the job status screen, and thus the process advances to step S1611 to execute the post-processing, thereby ending this processing.

FIG. 16 is a flowchart for explaining the destination selection processing in step S1303 of FIG. 12 or step S1603 of FIG. 14.

In step S1901, the CPU 111 determines whether a FAX modem is mounted in the image communicating apparatus 101. If it is determined that the FAX modem is mounted, the process advances to step S1902; otherwise, the process advances to step S1903. In step S1902, the CPU 111 acquires a destination list including a FAX destination from the address book stored in the storage unit 113, and advances to step S1905 to display the address book screen on the operation unit 114.

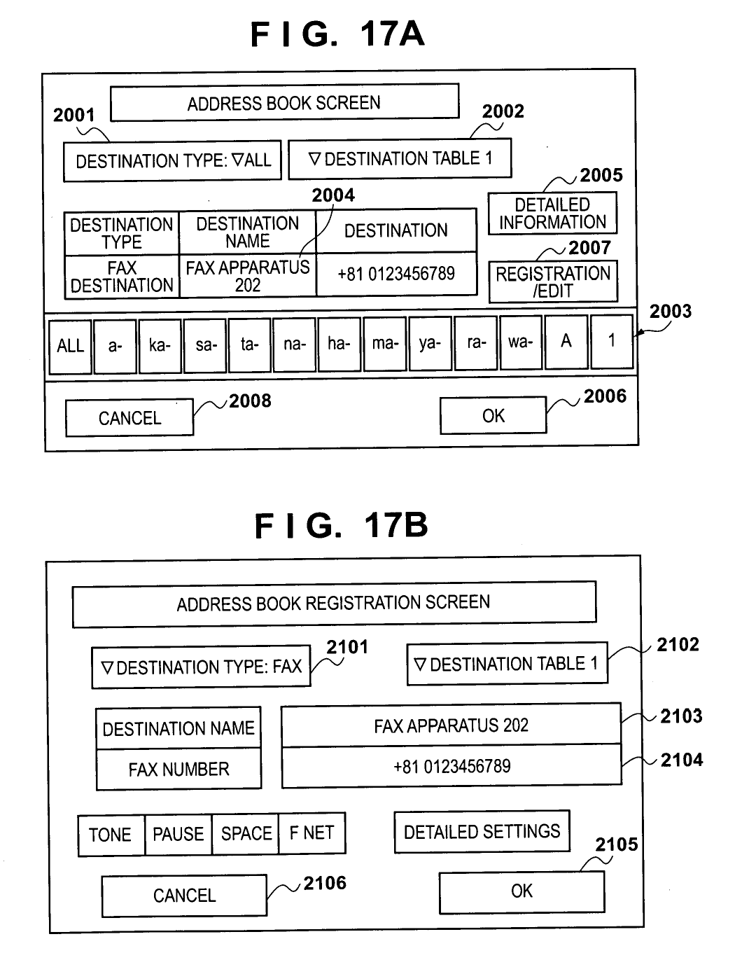

FIG. 17A is a view showing an example of the address book screen displayed on the display unit of the operation unit 114 in step S1905.

A destination type button 2001 is a button for designating a specific destination type, and can be used to narrow down the destinations. A destination table button 2002 is a button for narrowing down the destination table. Buttons 2003 are each used to narrow down the names of the destinations using phonetic characters. The destination list narrowed down by these buttons 2001, 2002, and 2003 is displayed in an address display region 2004. Referring to FIG. 17A, the FAX apparatus 202 shown in FIG. 2 is displayed as a FAX destination in the address display region 2004. If a detailed information button 2005 is pressed in a state in which the destination displayed in the address display region 2004 is selected, detailed information of the currently selected destination can be confirmed.

Referring back to FIG. 16, if the CPU 111 determines in step S1901 that no FAX modem is mounted, the process advances to step S1903, and the CPU 111 acquires, from the storage unit 113, a setting indicating whether to use the FAX server, and determines whether the setting has been made to use the FAX server. If it is determined that the setting has been made to use the FAX server, the process advances to step S1902; otherwise, the process advances to step S1904 and the CPU 111 acquires the destination list including no FAX destination from the address book, thereby advancing to step S1905.

In step S1905, the CPU 111 displays the address book screen shown in, for example, FIG. 17A on the operation unit 114. The process advances to step S1906, and the CPU 111 determines whether an OK button 2006 has been pressed on the address book screen to issue a destination confirmation instruction. If it is determined that the OK button 2006 has been pressed, the process advances to step S1907, and the CPU 111 determines whether there is a selected destination among the destinations displayed in the address display region 2004. If there is a selected destination, the process advances to step S1908, and the CPU 111 adds the selected destination as a sending destination, thereby ending this processing. On the other hand, if it is determined in step S1907 that no destination has been selected, this indicates that the OK button 2006 has been pressed without selecting any destination, and thus the process directly ends.

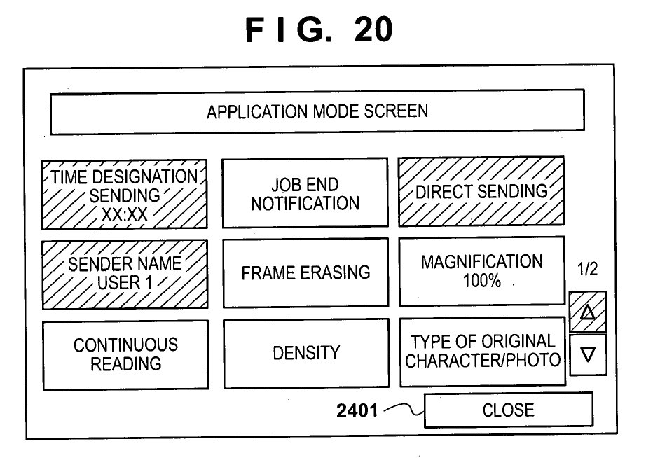

On the other hand, if it is determined in step S1906 that no OK button 2006 has been pressed, the process advances to step S1909, and the CPU 111 determines whether a registration/edit button 2007 shown in FIG. 20 has been pressed to issue an instruction of adding (registering) a destination to the address book. If it is determined that the registration/edit button 2007 has been pressed, the process advance to step S1910; otherwise, the process advances to step S1917. In step S1917, the CPU 111 determines whether a cancel button 2008 has been pressed on the screen shown in FIG. 17A. If it is determined that the cancel button 2008 has been pressed, the process ends; otherwise, the process returns to step S1906. Similarly to step S1901, the CPU 111 determines in step S1910 whether the FAX modem is mounted in the image communicating apparatus 101. If it is determined that the FAX modem is mounted, the process advances to step S1911, and the CPU 111 displays an address book registration screen shown in FIG. 17B on the operation unit 114, thereby advancing to step S1912.

FIG. 17B is a view showing an example of the address book registration screen which is displayed on the display unit of the operation unit 114 in step S1911 and on which a FAX destination can also be registered.

Referring to FIG. 17B, “FAX” is designated in a destination type 2101, and “destination table 1” is selected in a destination table 2102, similarly to FIG. 17A. In addition, “FAX apparatus 202” is displayed in a destination name 2103, and the FAX number of the destination is displayed in a FAX number 2104. If an OK button 2105 is pressed, contents on this screen are registered in the address book.

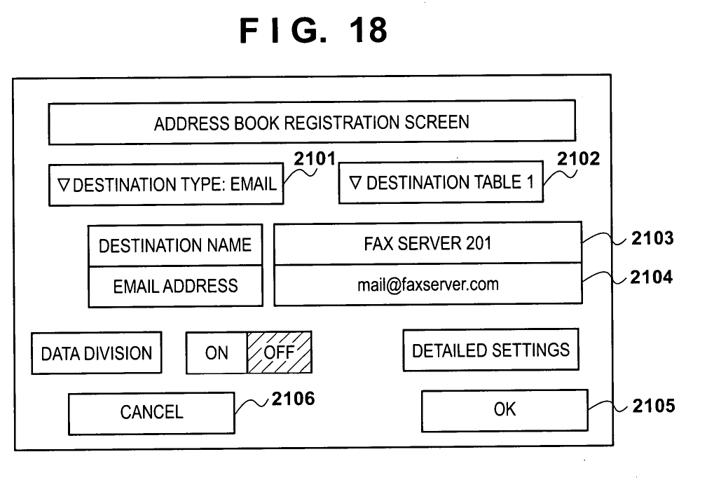

On the other hand, if the CPU 111 determines in step S1910 that no FAX modem is mounted, the process advances to step S1915, and the CPU 111 acquires, from the storage unit 113, the setting indicating whether to use the FAX server, and determines whether the setting has been made to use the FAX server. If it is determined that the setting has been made to use the FAX server, the process advances to step S1911 described above; otherwise, the process advances to step S1916. At this time, if a character string which the FAX server does not support is known in advance, the CPU 111 desirably displays a screen in a state in which such characters cannot be input. Examples of such characters are pause, tone, and F net. In step S1916, the CPU 111 displays an address book registration screen shown in FIG. 18, on which no FAX destination can be registered. Then, the process advances to step S1912.

FIG. 18 is a view showing an example of the address book registration screen which is displayed on the display unit of the operation unit 114 in step S1916 and on which no FAX destination can be registered.

As will be apparent by comparing FIGS. 17B and 18, in FIG. 18, “email” is designated in the destination type 2101, and “destination table 1” is selected in the destination table 2102, similarly to FIG. 17B. In addition, “FAX server 201” is displayed in the destination name 2103 and the email address of the destination is displayed in the email address 2104. If the OK button 2105 is pressed, contents on this screen are registered in the address book. This destination registration screen on which no FAX destination can be registered disables selection of FAX in the destination type 2101.

In step S1912, the CPU 111 determines whether the OK button 2105 has been pressed to issue a destination input completion instruction. If a destination input completion instruction has been issued, the process advances to step S1913, and the CPU 111 additionally registers, in the address book recorded in the storage unit 113, the contents input via the screen, thereby ending this processing. On the other hand, if it is determined that no OK button 2105 has been pressed, the process advances to step S1914, and the CPU 111 determines whether a cancel button 2106 has been pressed to issue a destination registration cancel instruction. If it is determined that a cancel instruction has been issued, the process ends; otherwise, the process returns to step S1912 to continue the processing.

With this destination selection processing, it is possible to switch an address book to be displayed in accordance with whether the FAX modem is mounted in the image communicating apparatus 101 and whether the setting has been made to use the FAX server. Then, it is possible to select a destination from the displayed address book, and set it as a sending destination. Furthermore, when a destination is registered in the address book or a destination is edited, it is also possible to switch a target address book in accordance with whether the FAX modem is mounted in the image communicating apparatus 101 and whether the setting has been made to use the FAX server.

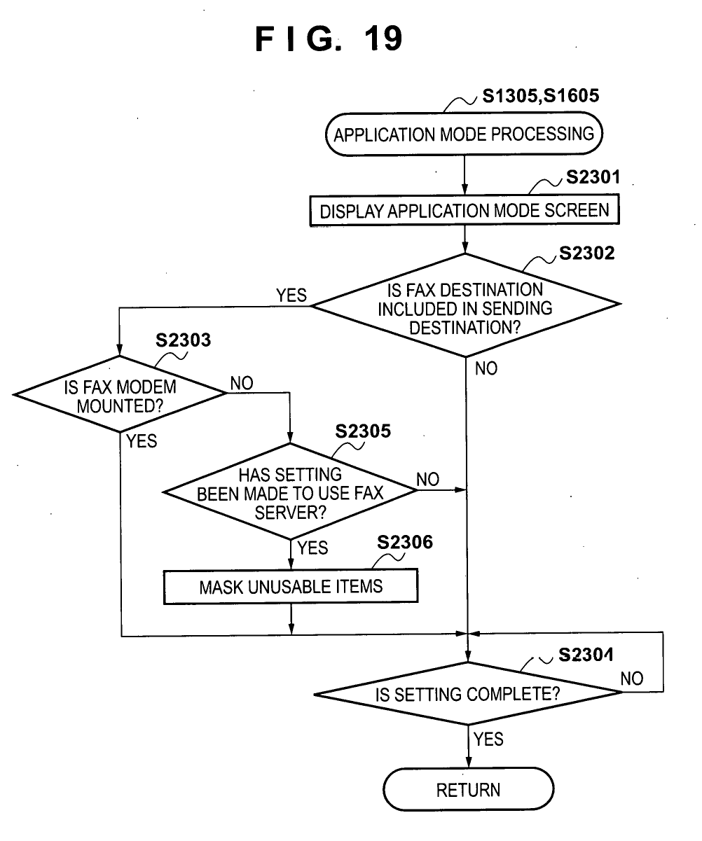

FIG. 19 is a flowchart for explaining the application mode processing in step S1305 of FIG. 12 or step S1605 of FIG. 14.

In step S2301, the CPU 111 displays an application mode screen shown in, for example, FIG. 20.

FIG. 20 is a view showing an example of the application mode screen displayed on the display unit of the operation unit 114 in step S2301.

The user can designate, via this screen, frame erasing, a magnification, a density, a type of original (character/photo), and the like in addition to a sending method such as time designation sending or direct sending. Referring to FIG. 20, none of time designation sending, direct sending, and a sender name can be designated.

The process advances to step S2302, and the CPU 111 determines whether the currently selected sending destination includes a FAX destination. If it is determined that a FAX destination is included, the process advances to step S2303; otherwise, the process advances to step S2304. In step S2303, the CPU 111 determines whether the FAX modem is mounted in the image communicating apparatus 101. If it is determined that the FAX modem is mounted, the process advances to step S2304. In step S2304, the CPU 111 determines whether a close button 2401 on the application mode screen has been pressed to complete setting, and waits until the close button 2401 is pressed, thereby ending this processing.

On the other hand, if it is determined in step S2303 that no FAX modem is mounted, the process advances to step S2305, and the CPU 111 acquires, from the storage unit 113, the setting indicating whether to use the FAX server, and determines whether the setting has been made to use the FAX server. If it is determined that the setting has been made to use the FAX server, the process advances to step S2306, and the CPU 111 displays the screen so as not to set the application mode that cannot be used for sending using the FAX server, thereby advancing to step S2304. Note that examples of the application mode that may be unusable for sending using the FAX server are direct sending, time designation sending, and designation of a sender name. In FIG. 20, the screen is displayed not to set these items. Note that as a display method of displaying the screen not to make these settings, these items may be grayed out or set in a non-display state. If it is determined in step S2305 that the setting has not been made to use the FAX server, the process advances to step S2304.

In the application mode processing, if the sending destination includes a FAX destination, no FAX modem is mounted, and the FAX server is used, the application mode that cannot be used for sending using the FAX server is made unselectable.

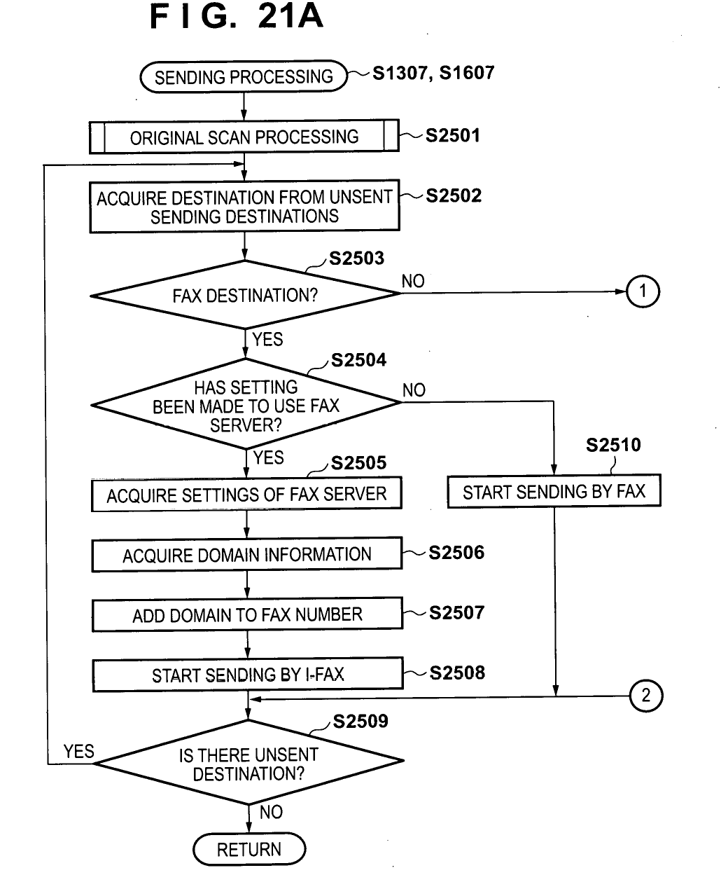

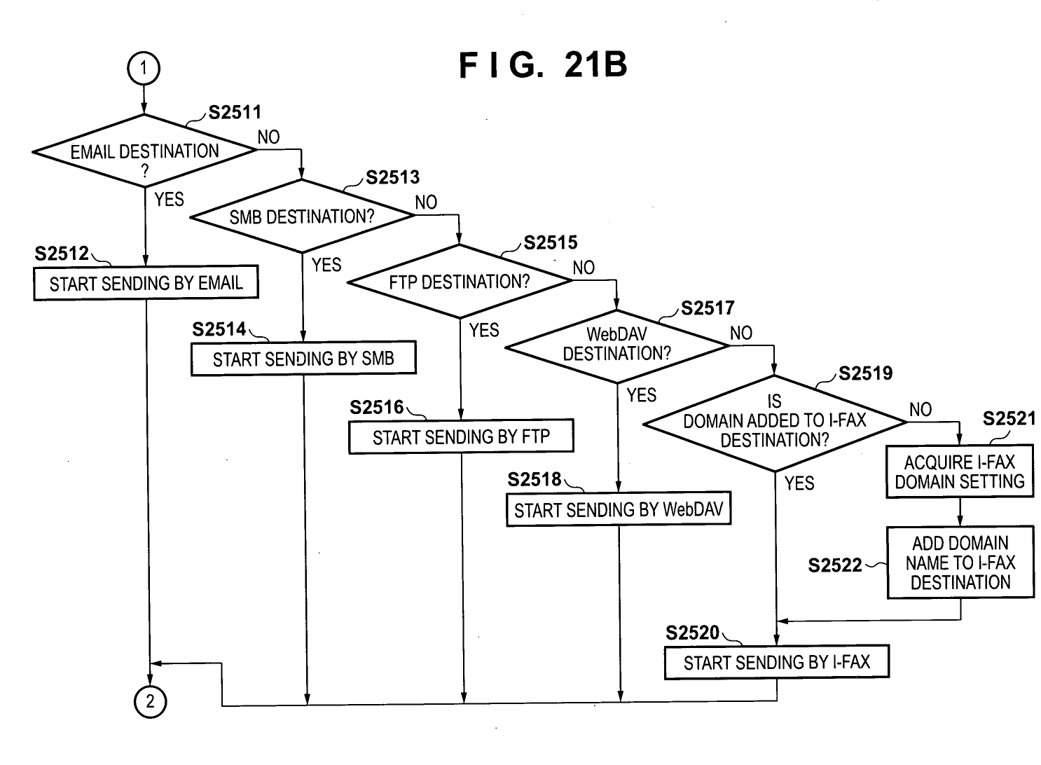

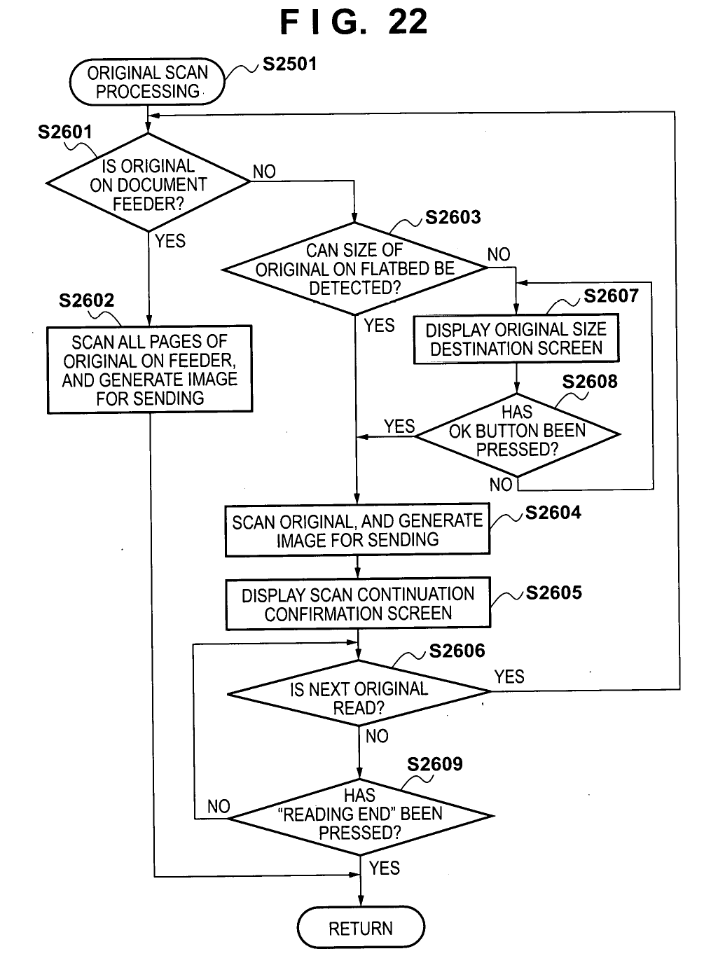

FIGS. 21A and 21B are flowcharts for explaining the sending processing in step S1307 of FIG. 12 or step S1607 of FIG. 14.

Upon start of this processing, the CPU 111 executes, in step S2501, original scan processing (to be described later with reference to the flowchart of FIG. 22). The process advances to step S2502, and the CPU 111 acquires one unsent destination from selected sending destinations. The process advances to step S2503, and the CPU 111 determines whether the destination acquired in step S2502 is a FAX destination. If it is determined that the acquired destination is a FAX destination, the process advances to step S2504, and the CPU 111 acquires, from the storage unit 113, the setting indicating whether to use the FAX server, and determines whether the setting has been made to use the FAX server. It is determined that the setting has been made to use the FAX server, the process advances to step S2505, and the CPU 111 acquires the settings of the FAX server from the storage unit 113. The process advances to step S2506, and the CPU 111 acquires domain information from the acquired information of the FAX server. In step S2507, the CPU 111 adds the domain information to the end of the FAX number of the acquired FAX destination. The process advances to step S2508, and the CPU 111 sends, by I-FAX, the image data generated by the original scan processing in step S2501 to the generated destination information. Then, the process advances to step S2509. In step S2509, the CPU 111 determines whether an unsent destination remains. If it is determined that an unsent destination remains, the process returns to step S2502 to repeat the above-described processing; otherwise, the process ends.

If the CPU 111 determines in step S2504 that the setting has not been made to use the FAX server, the process advances to step S2510. In step S2510, the CPU 111 sends, by FAX, using the FAX modem, the image data generated by the original scan processing in step S2501 to the destination acquired in step S2502. Then, the process advances to step S2509.

If it is determined in step S2503 that the acquired destination is not a FAX destination, the process advances to step S2511, and the CPU 111 determines whether the destination acquired in step S2502 is an email destination. If it is determined that the acquired destination is an email destination, the process advances to step S2512, and the CPU 111 sends, by email, the image data generated by the original scan processing in step S2501 to the destination acquired in step S2502. Then, the process advances to step S2509.

If it is determined in step S2511 that the acquired destination is not an email destination, the process advances to step S2513, and the CPU 111 determines whether the destination is an SMB destination. If it is determined the destination is an SMB destination, the process advances to step S2514, and the CPU 111 sends, by SMB, the image data generated by the original scan processing in step S2501 to the destination. Then, the process advances to step S2509.

If the CPU 111 determines in step S2513 that the destination is not an SMB destination, the process advances to step S2515 and the CPU 111 determines whether the destination is an FTP destination. If it is determined that the destination is an FTP destination, the process advances to step S2516, and the CPU 111 sends, by FTP, the image data generated by the original scan processing in step S2501 to the destination. Then, the process advances to step S2509.

If it is determined in step S2515 that the destination is not an FTP destination, the process advances to step S2517, and the CPU 111 determines whether the destination is a WebDAV destination. If it is determined that the destination is a WebDAV destination, the process advances to step S2518, and the CPU 111 sends, by WebDAV, the image data generated by the original scan processing in step S2501 to the destination. Then, the process advances to step S2509.

If it is determined in step S2517 that the destination is not a WebDAV destination, the process advances to step S2519, and the CPU 111 determines that the destination is an I-FAX destination, and determines whether the destination acquired in step S2502 includes a domain name. If it is determined that a domain name is included, the process advances to step S2520, and the CPU 111 sends, by I-FAX, the image data generated by the original scan processing in step S2501 to the destination. Then, the process advances to step S2509. If it is determined in step S2519 that the destination includes no domain name, the process advances to step S2521, and the CPU 111 acquires the I-FAX domain setting from the storage unit 113. Then, the process advances to step S2522, and the CPU 111 adds the domain to the end of the destination acquired in step S2502. After that, the process advances to step S2520, and the CPU 111 sends, by I-FAX, the image data generated by the original scan processing to the generated destination. Then, the process advances to step S2509.

With this processing, if the sending destination is a FAX destination and the FAX server is used, it is possible to perform I-FAX sending by automatically adding a domain to the FAX number of the FAX server with reference to the registered FAX server settings. In addition, it is possible to send data to a corresponding destination in accordance with whether the sending destination is an email destination, an SMB destination, an FTP destination, a WebDAV destination, or an I-FAX destination. In the case of an I-FAX destination, if the destination is not added with a domain, it is possible to automatically add a domain to the I-FAX destination with reference to the registered I-FAX settings, thereby performing I-FAX sending.

FIG. 22 is a flowchart for explaining the original scan and sending processing in step S2501 of FIG. 21A.

Upon start of this scan processing, the CPU 111 determines in step S2601 whether an original to be scanned is placed on the document feeder (ADF) of the reader unit 115. If it is determined that an original is placed, the process advances to step S2602, and the CPU 111 scans all the pages of the original placed on the document feeder, and generates image data for sending, thereby ending this processing.

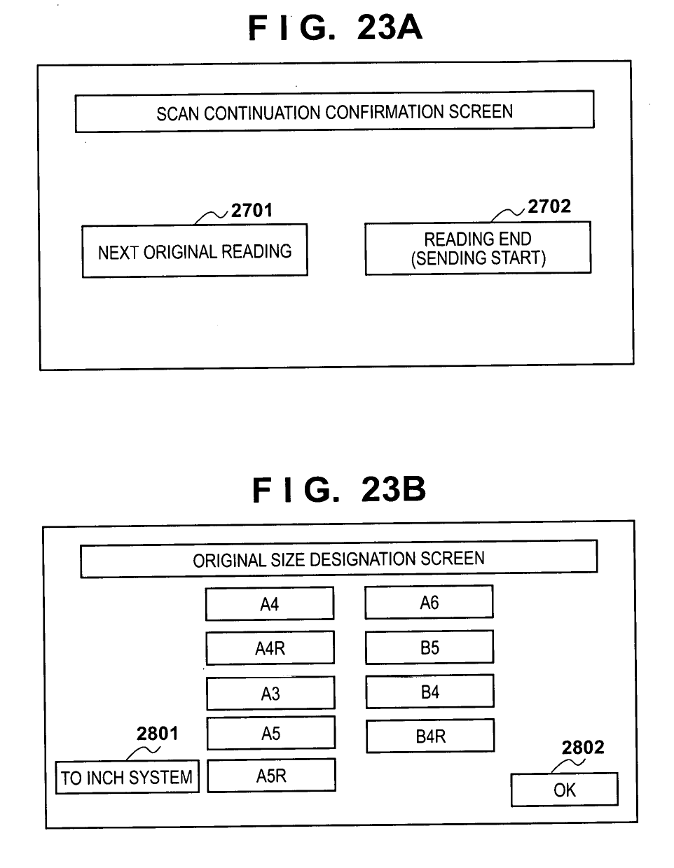

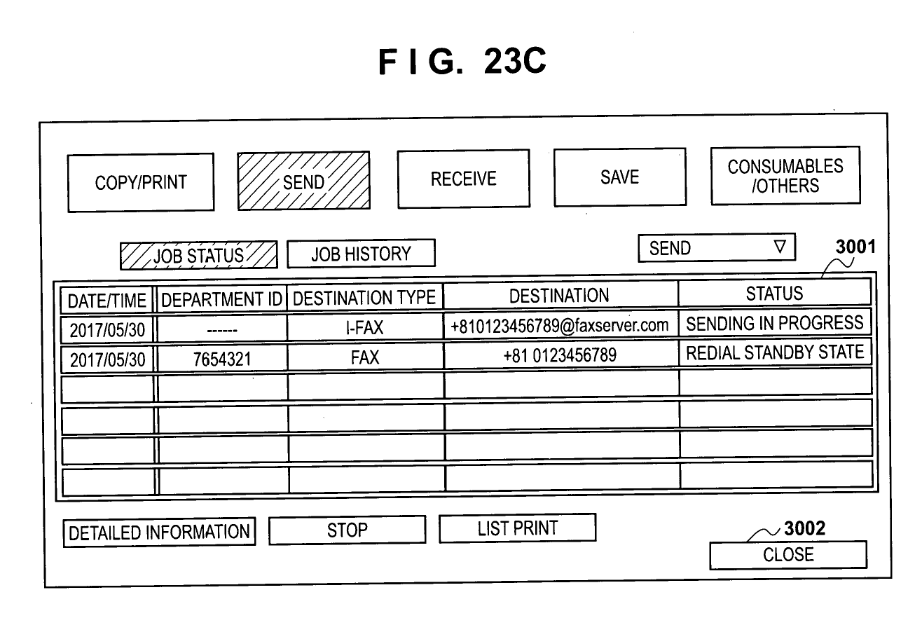

On the other hand, if it is determined in step S2601 that the original to be scanned is not placed on the document feeder, the process advances to step S2603, and the CPU 111 determines whether an original size can be detected by the flatbed of the reader unit 115. If it is determined that an original size can be detected, the process advances to step S2604, and the CPU 111 scans the original by the flatbed, and generates image data for sending. The process advances to step S2605, and the CPU 111 displays a scan continuation confirmation screen shown in, for example, FIG. 23A.

FIG. 23A is a view showing an example of the scan continuation confirmation screen displayed on the display unit of the operation unit 114 in step S2605.

On the screen shown in FIG. 23A, a “next original reading” button 2701 is a button for instructing to read the next original, and a “reading end” button 2702 is a button for instructing to end the reading of the original and start sending.

In step S2606, the CPU 111 determines whether the “next original reading” button 2701 has been pressed to issue a next original reading instruction. If it is determined that a next original reading instruction has been issued, the process returns to step S2601. If it is determined that no “next original reading” button 2701 has been pressed, the process advances to step S2609, and the CPU 111 determines whether the “reading end” button 2702 has been pressed to issue an original reading end instruction. If it is determined that an original reading end instruction has been issued, the process ends; otherwise, the process returns to step S2606.

If the CPU 111 determines in step S2603 that the original size cannot be detected by the flatbed of the reader unit 115, the process advances to step S2607, and the CPU 111 displays an original size designation screen shown in, for example, FIG. 23B.

FIG. 23B is a view showing an example of the original size designation screen displayed on the display unit of the operation unit 114 in step S2607.

In this example, buttons of various sizes as original sizes are displayed. The user can designate an original size by pressing one of these buttons. Note that the user can designate an original size of an inch system size exemplified by a letter size and a legal size by pressing a “to inch system” button 2801.

In step S2608, the CPU 111 determines whether an OK button 2802 has been pressed on this screen to complete the setting of the original size. If it is determined that the setting of the original size is complete, the process advances to step S2604, and the CPU 111 scans the original on the flatbed by the original size designated on the screen. If it is determined in step S2608 that no OK button 2802 has been pressed, the process returns to step S2607.

With this processing, the original size of the original placed on the ADF can be detected, and thus reading processing can be executed in accordance with the detected size. For the original placed on the flatbed (platen glass), the pages of the original are read one by one. At this time, if the size of the original cannot be detected, the user can designate an original reading size by designating the original size on the original size designation screen.

FIG. 24 is a flowchart for explaining the job status processing in step S1310 of FIG. 12 or step S1610 of FIG. 14.

Upon start of this processing, the CPU 111 displays, in step S2901, a job status determination screen shown in, for example, FIG. 23C.

FIG. 23C is a view showing an example of the job status determination screen displayed on the display unit of the operation unit 114 in step S2901.

In the example of FIG. 23C, the job statuses of send jobs are displayed. It is apparent that I-FAX sending to the FAX apparatus 202 using the FAX server is in progress, and FAX sending to the FAX apparatus 202 is in a redial standby state.

The process advances to step S2902, and the CPU 111 acquires pieces of information of various send jobs executed in the sending processing. Next, the process advances to step S2903, and the CPU 111 acquires one piece of unprocessed job information from the acquired pieces of job information. In step S2904, the CPU 111 determines whether the job of the acquired job information is a job targeting a FAX destination. If it is determined that the job is a job targeting the FAX destination, the process advances to step S2905, and the CPU 111 determines whether the job is a send job using the FAX server. If it is determined in step S2905 that the job is a send job to the target FAX destination using the FAX server, the process advances to step S2906, and the job is displayed as an I-FAX send job in a status 3001 on the job status determination screen. Then, the process advances to step S2907. In step S2907, the CPU 111 determines whether there is unprocessed job information among the pieces of job information acquired in step S2902. If there is no unprocessed information, the process advances to step S2908; otherwise, the process returns to step S2903. In step S2908, the CPU 111 determines whether a close button 3002 on the status determination screen has been pressed. If it is determined that the close button 3002 has been pressed, the process ends; otherwise, the process advances to step S2910.

If it is determined in step S2904 that the job is not a send job targeting a FAX destination or if it is determined in step S2905 that the job is not a send job using the FAX server, the process advances to step S2909. In step S2909, the CPU 111 displays the information of the send job intact in the status 3001 on the job status determination screen, and then the process advances to step S2907.

In step S2910, the CPU 111 determines whether there is a send job whose state has changed since the job information was acquired. Examples of the change of the send job are send completion and a send error. If it is determined in step S2910 that there is a send job whose state has changed, the process advances to step S2911, and the CPU 111 reflects the state after the change of the send job on the status 3001 of the job status determination screen. Then, the process returns to step S2907. If there is no send job whose state has changed, the process returns to step S2907 to continue the processing.

With this processing, display processing can be performed by distinguishing between FAX sending using the FAX server and other FAX sending.

FIG. 25 is a flowchart for explaining the post-processing in step S1311 of FIG. 12 or step S1611 of FIG. 14.

Upon start of the post-processing, the CPU 111 deletes, in step S3101, the sending destination designated in step S1908 of FIG. 16 to set a state in which no sending destination is designated, thereby ending this processing.

In the above-described embodiment, the form in which the setting indicating whether to use the FAX server at the time of FAX sending is registered in advance in the storage unit 113 is adopted. However, the present invention is not limited to this. For example, an embodiment in which the setting is set as part of the application mode and made every time a send job is executed is also applicable.

According to the above-described embodiment, the user who has used the FAX function of the image communicating apparatus can send data from the image communicating apparatus to the Internet FAX service without any unnatural feeling.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-167659, filed Aug. 31, 2017, which is hereby incorporated by reference herein in its entirety.

What is claimed is:

1. An image communicating apparatus comprising:
a determination unit configured to determine whether to use a FAX server for FAX sending;
an addition unit configured to add, if the determination unit determines to use the FAX server for the FAX sending, domain information of the FAX server to a destination of the FAX sending; and
a sending unit configured to send an image to the destination of the FAX sending, that has been added with the domain information by the addition unit.

2. The apparatus according to claim 1, wherein the addition unit adds the domain information to an end of a FAX number indicating the destination of the FAX sending.

3. The apparatus according to claim 1, further comprising a registration unit configured to register information indicating whether to use the FAX server and register, if the FAX server is used, an address and domain information of the FAX server,
wherein the determination unit performs determination based on contents registered in the registration unit.

4. The apparatus according to claim 1, further comprising a registration unit configured to register information indicating whether to use the FAX server and register, if the FAX server is used, an address and domain information of the FAX server,
wherein the addition unit adds the domain information registered in the registration unit.

5. The apparatus according to claim 1, further comprising:
a setting unit configured to set whether to automatically add domain information to an I-FAX sending destination and set the domain information; and
a second addition unit configured to add, if the destination of the FAX sending is an I-FAX destination, the domain information to the I-FAX sending destination in accordance with the setting by the setting unit.

6. The apparatus according to claim 1, further comprising:
a display unit configured to display an address book; and
a designation unit configured to designate the destination of the FAX sending from the displayed address book,
wherein if the image communicating apparatus can perform FAX sending, the display unit displays an address book including a FAX destination.

7. The apparatus according to claim 6, wherein the FAX sending can be performed in one of a case in which the image communicating apparatus mounts a FAX modem and a case in which sending via the FAX server is set.

8. A control method of controlling an image communicating apparatus, comprising:
determining whether to use a FAX server for FAX sending;
adding, if it is determined to use the FAX server for the FAX sending, domain information of the FAX server to a destination of the FAX sending; and
sending an image to the destination of the FAX sending, that has been added with the domain information.

9. A non-transitory computer-readable storage medium storing a program for causing a computer to:
determine whether to use a FAX server for FAX sending;
add, if it is determined to use the FAX server for the FAX sending, domain information of the FAX server to a destination of the FAX sending; and
send an image to the destination of the FAX sending, that has been added with the domain information.
